(19) United States
(12) Patent Application Publication
(10) Pub. No.: US 2016/0011754 A1
(43) Pub. Date: Jan. 14, 2016

(54) METHOD AND SYSTEM FOR VIRTUALIZED SENSORS IN A MULTI-SENSOR ENVIRONMENT

(71) Applicant: DELL PRODUCTS, L.P., Round Rock, TX (US)

(72) Inventors: MARK W. WELKER, WEST LAKE HILLS, TX (US); CLAUDE LANO COX, AUSTIN, TX (US); LIAM B. QUINN, AUSTIN, TX (US); ABU SHAHER SANAULLAH, AUSTIN, TX (US)

(73) Assignee: DELL PRODUCTS, L.P., Round Rock, TX (US)

(21) Appl. No.: 14/326,578

(22) Filed: Jul. 9, 2014

(51) Int. Cl. G06F 3/0484

(52) U.S. Cl. CPC G06F 3/04847; G06F 3/04842

(57) ABSTRACT

An information handling system (IHS) performs event monitoring to enable an application to maintain proper presentation of an application interface that is moved from a first display to a second display. A sensor manager allocates to the application executing on the IHS a first set of sensors that is associated with the first display upon which the application interface is presented. The sensor manager activates event monitoring associated with orientation of the first display using the first set of the identified sensors. The sensor manager enables the application to properly present the application interface on the first display using information from event monitoring. In response to detecting that the application interface is moved from the first display to the second display, the sensor manager dynamically allocates to the application a second set of sensors which is activated to perform event monitoring associated with orientation of the second display.

### BACKGROUND

1. Technical Field

The present disclosure generally relates to information handling systems (IHS) and in particular to multiple displays within information handling systems.

2. Description of the Related Art

As the value and use of information continue to increase, individuals and businesses seek additional ways to process and store information. One option available to users is information handling systems. An information handling system (IHS) generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems are designed or configured as dual display systems having two connected panel displays or monitors. An end user will require that a dual display smart computer system react naturally, with respect to the end users viewing orientation when the monitors are rotated or viewed at different angles as part of a natural usage mode, by properly displaying the content on each screen of a respective display. In some designs, the dual display system may have sensors associated with each monitor. In these dual display systems, an executing application is typically able to utilize the set of sensors associated with the display rendering the user interface for the application. The set of sensors mapped to the display used by the applications user interface enable detection of the monitor position, as well as other features of the display panel. However, if an application is moved from one panel display to the other panel display by the user, the set of sensors mapped from the source panel (first panel display) will still be associated with the application. In order to address this problem, a number of system designs considered the use of switches embedded in the hinges in order to allow the system to be aware of the position of both displays. However, these designs limit the applications that can be displayed across multiple screens.

### BRIEF SUMMARY

Disclosed are a method and an information handling system (IHS) that maintains a proper presentation of an application interface when the application interface is moved from a first display to a second display in a multi-display system. According to one aspect, a sensor manager is used to control and map each of a plurality of identified sensors within the IHS to a particular one or more of the multiple displays. An executing application which presents an application interface on a first display of the IHS sends a request for monitoring of the first display's orientation to the sensor manager. Following receipt of a request for event monitoring associated with an orientation of the first display, the sensor manager allocates to the application a first set of the identified sensors that is associated with the first display. The sensor manager activates event monitoring associated with orientation of the first display using the first set of the identified sensors. The sensor manager enables the application to properly present the application interface on the first display using information from event monitoring. In response to detecting that presentation of the application, the interface switches from the first display to the second display, the sensor manager dynamically allocates to the application a second set of the identified sensors which are activated to perform event monitoring associated with orientation of the second display.

According to another aspect, the sensor manager (i) registers sensor event listeners that monitor sensor changes associated with a display on which the application interface is presented and (ii) unregisters the previously registered sensor event listeners when the application interface is moved from the first display to the second display. As a result, the sensor manager continuously tracks sensor events for each of multiple displays with a set of physical sensors associated with each display. Furthermore, the sensor manager allows the application to provide the same application code set to be associated with event monitoring on the different displays.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates an example dual-display information handling system (IHS) within which various aspects of the disclosure can be implemented, according to one or more embodiments;

FIG. 2 depicts an IHS with multiple displays having respective sets of sensors, according to one or more embodiments;

FIG. 3 illustrates a sensor switching sub-system architecture that supports continuous display event tracking, according to one embodiment;

FIG. 4 is a flow chart illustrating a method for monitoring sensor events in order to maintain a proper presentation of an application interface when the application interface is moved from a first display to a second display, according to one embodiment; and

FIG. 5 is a flow chart illustrating a method for monitoring sensor changes associated with a display on which an application interface is presented, in accordance with one or more embodiments.

### DETAILED DESCRIPTION

The illustrative embodiments provide a method and an information handling system (IHS) that maintains a proper presentation of an application interface when the application interface is moved from a first display to a second display in a multi-display IHS. Each display of the IHS has specific physical sensors associated therewith, embedded within the panels of the display. According to one aspect, a sensor manager maps each of a plurality of identified sensors within the IHS to a particular one or more of the multiple displays. An executing application which presents an application interface on a first display of the IHS sends a request for monitoring of the first display's orientation to the sensor manager. Following receipt of the request for event monitoring associated with display orientation, the sensor manager allocates to the application a first set of the identified sensors that is associated with the first display. The sensor manager activates event monitoring associated with orientation of the first display using the first set of the identified sensors. The sensor manager enables the application to properly present the application interface on the first display using information from event monitoring. In response to detecting that presentation of the application interface switches from the first display to the second display, the sensor manager dynamically allocates to the application a second set of the identified sensors which are activated to perform event monitoring associated with orientation of the second display.

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

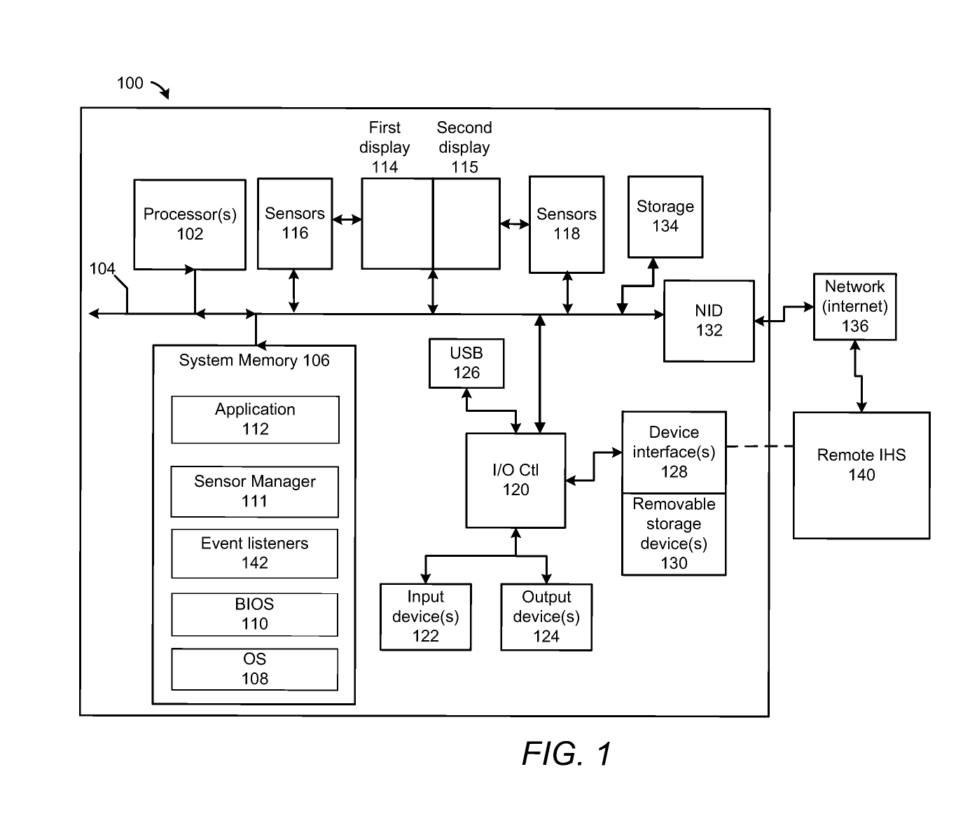

FIG. 1 illustrates a block diagram representation of an example information handling system (IHS) 100, within which one or more of the described features of the various embodiments of the disclosure can be implemented. For purposes of this disclosure, an information handling system, such as IHS 100, may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a handheld device, personal computer, a server, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring specifically to FIG. 1, example IHS 100 includes one or more processor(s) 102 coupled to system memory 106 via system interconnect 104. System interconnect 104 can be interchangeably referred to as a system bus, in one or more embodiments. Also coupled to system interconnect 104 is storage 134 within which can be stored one or more software and/or firmware modules and/or data (not specifically shown). In one embodiment, storage 134 can be a hard drive or a solid state drive. The one or more software and/or firmware modules within storage 134 can be loaded into system memory 106 during operation of IHS 100. As shown, system memory 106 can include therein a plurality of modules, including Basic Input/Output System (BIOS) 110, operating system (O/S) 108, applications 112 and firmware (not shown). The various software and/or firmware modules have varying functionality when their corresponding program code is executed by processor(s) 102 or other processing devices within IHS 100.

In one or more embodiments, BIOS 110 comprises additional functionality associated with unified extensible firmware interface (UEFI), and can be more completely referred to as BIOS/UEFI 110 in these embodiments. The various software and/or firmware modules have varying functionality when their corresponding program code is executed by processor(s) 102 or other processing devices within IHS 100.

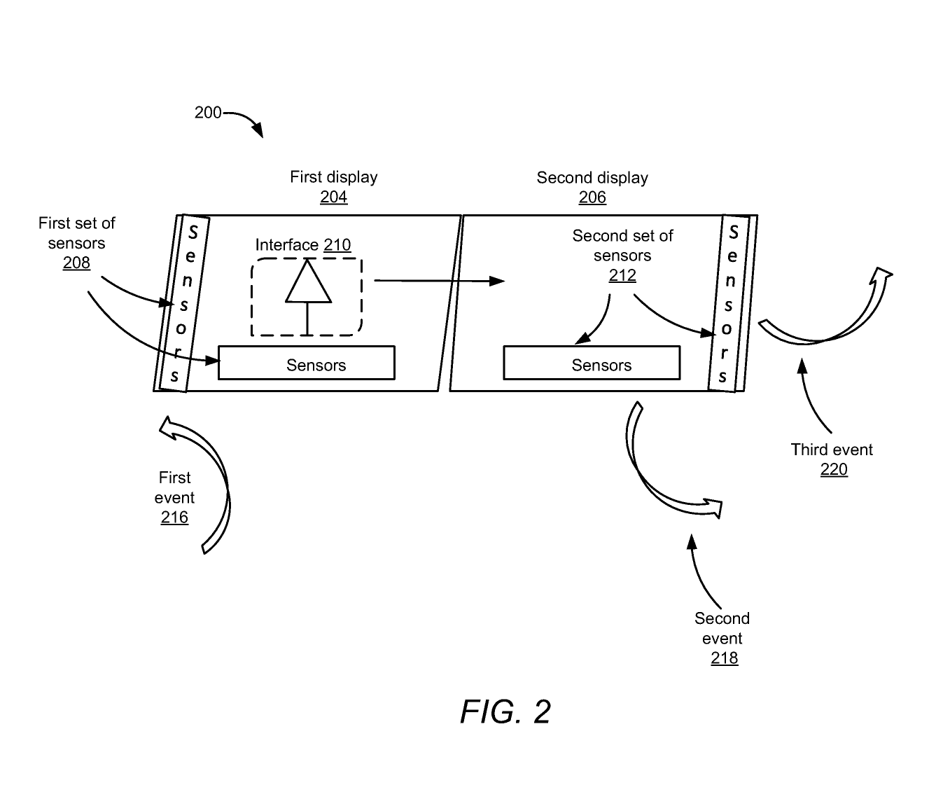

IHS 100 further includes one or more input/output (I/O) controllers 120 which support connection to and processing of signals from one or more connected input device(s) 122, such as a keyboard, mouse, touch screen, or microphone. I/O controllers 120 also support connection to and forwarding of output signals to one or more connected output device(s) 124, such as a monitor or display device or audio speaker(s). Specifically, as illustrated, I/O controllers 120 are connected to each of first display 114 and second display 115, each of which has a specific set of one or more sensors 116, 118 associated therewith. Sensors 116 and sensors 118 can respectively include one or more of: (a) motion sensors; (b) position sensors; (c) gyros; (d) accelerometers; and (e) synthetic sensors that are implemented using multiple sensors. First display 114 and second display 115 collectively represent a multi-display system upon which application 112 can present an application interface 212 (FIG. 2). In one embodiment, first display 114 and second display 115 are coupled to a graphics processing unit (GPU) which controls access to first display 114 and second display 115. In addition, IHS 100 includes universal serial bus (USB) 126 which is coupled to I/O controller 120. Additionally, in one or more embodiments, one or more device interface(s) 128, such as an optical reader, a universal serial bus (USB), a card reader, Personal Computer Memory Card International Association (PCMCIA) port, and/or a high-definition multimedia interface (HDMI), can be associated with IHS 100. Device interface(s) 128 can be utilized to enable data to be read from or stored to corresponding removable storage device(s) 130, such as a compact disk (CD), digital video disk (DVD), flash drive, or flash memory card. In one or more embodiments, device interface(s) 128 can also provide an integration point for connecting other device(s) to IHS 100. In one implementation, IHS 100 connects to remote IHS 140 using device interface(s) 128. In such implementation, device interface(s) 128 can further include General Purpose I/O interfaces such as I²C, SMBus, and peripheral component interconnect (PCI) buses.

IHS 100 comprises a network interface device (NID) 132. NID 132 enables IHS 100 to communicate and/or interface with other devices, services, and components that are located external to IHS 100. These devices, services, and components can interface with IHS 100 via an external network, such as example network 136, using one or more communication protocols. In particular, in one implementation, IHS 100 uses NID 132 to connect to remote IHS 140 via an external network, such as network 136.

Network 136 can be a wired local area network, a wireless wide area network, wireless personal area network, wireless local area network, and the like, and the connection to and/or between network 136 and IHS 100 can be wired or wireless or a combination thereof. For purposes of discussion, network 136 is indicated as a single collective component for simplicity. However, it is appreciated that network 136 can comprise one or more direct connections to other devices as well as a more complex set of interconnections as can exist within a wide area network, such as the Internet.

With specific reference now to FIG. 2, there is depicted an IHS with two displays having respective sets of sensors that are utilized to provide various functional aspects of the described embodiments. Dual-display system 200 comprises first display 204 and second display 206. First display 204 comprises a first set of sensors 208. Also illustrated as being visually displayed on first display 204 is application interface 210. Second display 206 comprises a second set of sensors 212. FIG. 2 also illustrates several orientation events (depicted via curved arrows), which correspond to specific actions/forces that orient respective displays in various different positions. In particular, first event 216, second event 218 and third event 220 are illustrated within FIG. 2. First event 216 affects and/or changes the orientation of first display 204, while second event 218 and third event 220 affect and/or change the orientation of second display 206. The different events can occur independently of one another or be completed concurrently in or within an overlapping timeframe.

In one embodiment, operating system (OS) 108 executing on IHS 100 provisions a sensor set that is associated with a display upon which an application (user) interface is presented. Sensor manager 111 maps each of multiple sensors 116 within IHS 100 to a particular one or more of the multiple displays. In the specific example, sensor manager 111 maps first set of sensors 208 to first display 204 based on the first set of sensors 208 being embedded within or physically coupled to first display 204. In addition, sensor manager 111 maps second set of sensors 212 to second display 206 based on the second set of sensors 212 being embedded within or physically coupled to second display 206. Sensor manager 111 receives a request for event monitoring associated with an orientation of a first display 204 upon which the application interface 210 of executing application 112 is being presented. In one embodiment, executing application 112 which initially presents application interface 210 on a first display of IHS 100 sends the request for monitoring of display orientation to sensor manager 111. In another embodiment, sensor manager 111 is configured to detect activation of application 112 and can initiate a process to provide monitoring services without requiring a specific and/or current request from application 112. In response to determining that a first presentation of application interface 210 occurs on first display 204, sensor manager 111 allocates to application 112 the first set of sensors 208 that is embedded within, associated with, or mapped to first display 204. In particular, sensor manager 111 allocates the first set of sensors 208 to application 112 in order to monitor the orientation of a display upon which application interface 210 is presented. Sensor manager 111 activates event monitoring associated with an orientation of first display 204 using first set of sensors 208. Event monitoring is performed for events that are detectable by a sensor and includes monitoring/tracking of individual events and change events associated with a previously detected event. For example, sensor manager 111 detects first (orientation) event 216 as a sensor event which enables application 112 to maintain a proper presentation of application interface 210 on first display 204. In one embodiment, sensor manager 111 activates event monitoring associated with the orientation of first display 204 using first set of sensors 208 following a provisioning by OS 108 of first set of sensors 208 to application 112 for monitoring of sensor events on first display 204. Sensor events include events affecting orientation and/or position of a display and which are detectable by at least one of first set of sensors 208. First set of sensors 208 can include one or more of: (a) motion sensors; (b) position sensors; (c) gyros; (d) accelerometers; and (e) synthetic sensors that are implemented using multiple sensors.

In one embodiment, sensor manager 111 receives from application 112 a request for information identifying available sensors and sensor capabilities. According to one aspect of the disclosure, information identifying sensor capabilities comprise information identifying a maximum detection range, power requirements, and a measurement scale resolution. In response to receipt of the request regarding sensor availability and capabilities, sensor manager 111 provides application 112 with the requested information, which enables application 112 to calculate, using the information provided, a rate at which application 112 can acquire sensor data to allow application 112 to maintain the proper presentation of application interface 210. For example, based on sensor capabilities, application 112 can determine a set of sensors that can provide application 112 with information that allows application 112 to properly present application interface 210 and provide a high quality user/viewer experience. In one implementation, sensor manager 111 registers sensor event listeners (for the executing application) that monitor sensor changes associated with a display on which the application interface is presented.

During execution of application 112, sensor manager 111 detects when a user switches presentation of application interface 210 from first display 204 to second display 206 of the multiple displays. In response to detecting that presentation of application interface 210 switches from first display 204 to second display 206, sensor manager 111 dynamically allocates to application 112 the second set of sensors 212 to perform event monitoring associated with second display 206. Following allocation of second set of sensors 212, sensor manager 111 activates event monitoring associated with an orientation of second display 206 using second set of sensors 212 to enable application 112 to maintain a proper presentation of application interface 210 on second display 206.

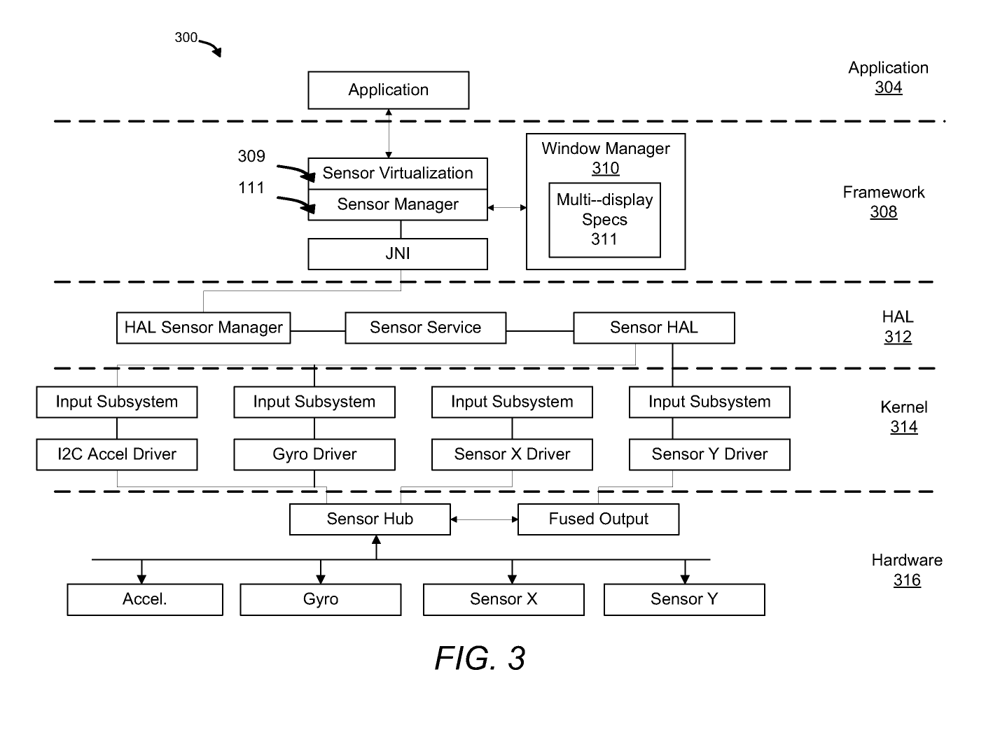

In one embodiment, in response to application interface 210 being moved from first display 204 to second display 206, sensor manager 111 receives from window manager 310 (FIG. 3) a notification that application interface 210 was moved to second display 206. In response to receipt of the notification from window manager 310, sensor manager 111 registers with window manager 310 a second event listener that monitors sensor changes associated with second display 206. A selected number of event listeners can listen for different kinds of events from a number of event sources. These events are detectable by respective sensors. For example, application 112/sensor manager 111 can create one listener per event source. Alternatively, application 112 can have a single listener for all events from all sources. Application 112 can even have more than one listener for a single kind of event from a single event source. Sensor manager 111 can register multiple listeners to be notified of events of a particular type from a particular source. Additionally and/or responsive to registering the second event listener, sensor manager 111 unregisters the first event listener that was previously registered to monitor sensor changes at first display 204. The first and second event listeners are collectively illustrated as event listeners 142 (FIG. 1).

Although a single application is described, sensor manager 111 can be configured to provide event monitoring for multiple executing applications which concurrently present respective application interfaces on the multi-display system of IHS 100.

Those of ordinary skill in the art will appreciate that the hardware, firmware/software utility, and software components and basic configuration thereof depicted in FIGS. 1 and 2 may vary. The illustrative components of IHS 100/200 are not intended to be exhaustive, but rather are representative to highlight some of the components that are utilized to implement certain of the described embodiments. For example, different configurations of an IHS may be provided, containing other devices/components, which may be used in addition to or in place of the hardware depicted, and may be differently configured. The depicted example is not meant to imply architectural or other limitations with respect to the presently described embodiments and/or the general invention.

FIG. 3 illustrates a sensor (switching) sub-system architecture that supports continuous event tracking in a multi-display IHS, according to one embodiment. Sensor sub-system architecture 300 comprises a number of layers including (i) an Application layer 304, (ii) a Framework layer 308, (iii) a hardware abstraction layer (HAL) 312, (iv) a Kernel layer 314 and (v) a hardware layer 316. Application 112 resides in the Application layer 304 and communicates with the Framework layer 308 to make specific requests for services. The Framework layer 308 can provide a number of higher-level services to application 112 and includes a number of components including sensor virtualization component 309 and sensor manger 111, which is located below the sensor virtualization component 309. In one implementation, these higher levels are available to application 112 in the form of Java classes. Also illustrated in the framework layer 308 is Window manager 310. Window manager 310 includes multi-display specifications (“specs”) 311 which enable window manager 310 to determine a location of application interface 210 within a display and/or whether application interface 210 has been moved from a first display to a second display of a multi-display system. Application 112 communicates via the sensor virtualization component 309 with the sensor manager 111 to make service requests for event monitoring via sensors.

Sensor manager 111 communicates the request to HAL 312 via a Java Native Interface (JNI) which provides compatibility between application 112 and corresponding Java classes. Sensor manager 111 exists in the framework layer and in the HAL layer in which sensor manager 111 is illustrated as “HAL sensor manager”. Hardware abstractions are sets of routines in software that emulate some platform-specific details, giving programs direct access to the hardware resources such as sensors 116 (FIG. 1).

The HAL 312 is implemented in software, between the physical hardware of a computer and the software that runs on that computer. The HAL's function is to hide differences in hardware from most of the operating system kernel residing in the Kernel layer, so that most of the kernel-mode code does not need to be changed to run on systems with different hardware. Through hardware abstraction, application 112 can make device-independent requests for event monitoring for an application interface presented on any of the multiple displays. The kernel layer provides basic system functionality including process management, memory management and device management for devices including sensors, cameras, keypads, displays, etc. Also, the kernel handles networking and a vast array of device drivers, which facilitates interfacing to peripheral hardware.

The hardware layer comprises the various hardware resources, including sensor 116, which can be accessed via sensor hub. As illustrated, sensor 116 can include multiple sensors including a gyro and an accelerometer.

The virtualized sensor framework layer 308 enables efficient development of application 112 and continuous tracking of sensor events even if system 200 has multiple displays with a set of physical sensors associated with each display. Framework layer 308 allows existing code that utilizes sensors to properly work on a multiple display systems without any code modifications. In addition, virtualized sensor framework layer 308 allows seamless and continuous tracking to be performed using any other sensors that may be added to the platform subsequent to a deployment of an initial set of sensors.

Sensor manager 111 provides event monitoring for application 112 via an abstraction layer using a dynamically allocated set of physical sensors. The abstraction layer, illustrated as sensor virtualization 309, is located on top of sensor framework layer 308. Abstraction layer (e.g., sensor virtualization 309) enables an application user to move application interface 210 from first display 204 to second display 206, while application 112 is provided with continuous event monitoring by changing sets of physical sensors.

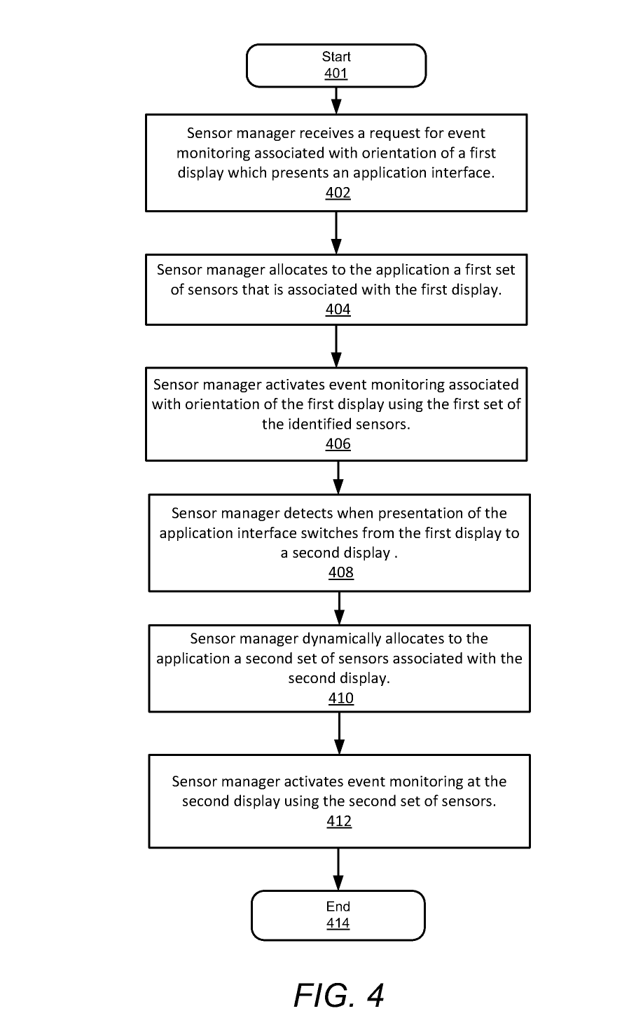

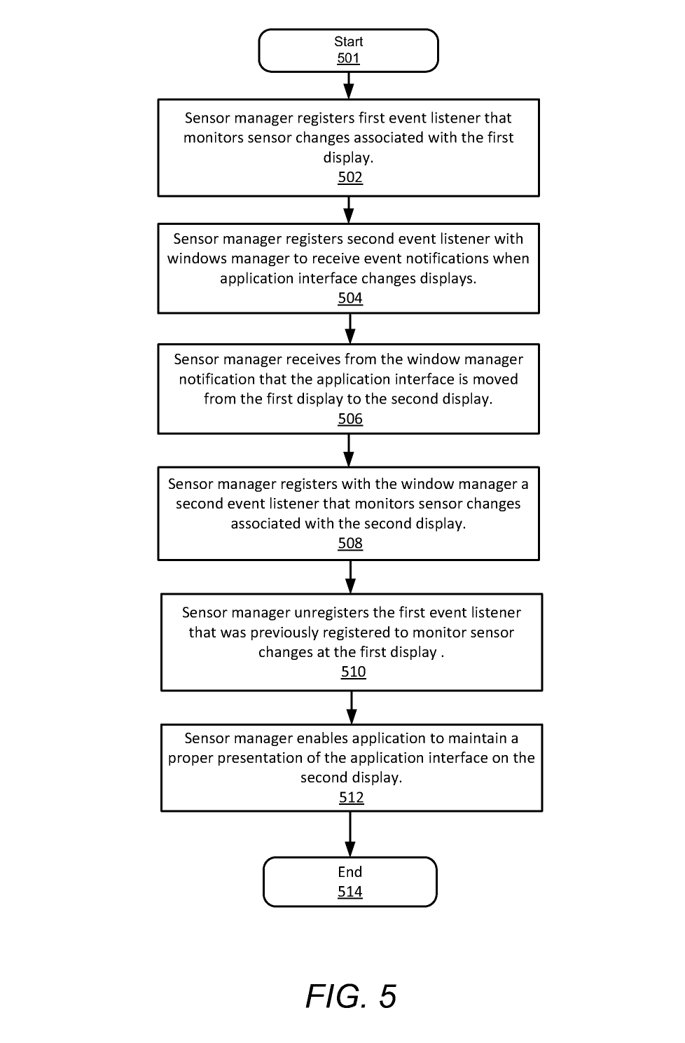

FIG. 4 and FIG. 5 present flowcharts illustrating example methods by which IHS 100 and specifically sensor manager 111 presented within the preceding figures performs different aspects of the processes that enable one or more embodiments of the disclosure. Generally, method 400 and method 500 collectively represent methods for selectively utilizing specific sets of sensors to perform continuous event tracking within IHS 100. The description of each method is provided with general reference to the specific components illustrated within the preceding figures. It is appreciated that certain aspects of the described methods may be implemented via other processing devices and/or execution of other code/firmware. In the discussion of FIG. 4 and FIG. 5, reference is also made to elements described in FIGS. 1-3.

FIG. 4 illustrates an example method for monitoring sensor events in order to maintain a proper presentation of an application interface when the application interface is moved from a first display to a second display. Method 400 begins at the start block 401 and proceeds to block 402 at which sensor manager 111 receives from application 112 a request for event monitoring associated with orientation of a first display on which an application interface is presented. Sensor manager 111 allocates to application 112 a first set of sensors 204 associated with the first display (block 404). Using the first set of sensors, sensor manager 111 activates event monitoring associated with orientation of the first display (block 406). The sensor manager enables the application to properly present the application interface on the first display using information from event monitoring. Sensor manager 111 detects when presentation of the application interface switches from the first display to a second display (block 408). In response to detecting the switch of displays, sensor manager 111 dynamically allocates to application 112 a second set of sensors 206 associated with the second display (block 410). Sensor manager 111 activates event monitoring at the second display using the second set of sensors (block 412). The process ends at block 414.

FIG. 5 illustrates an example method for monitoring sensor changes associated with a display on which an application interface is presented. Method 500 begins at start block 501 and proceeds to block 502 where sensor manager 111 registers, for the application, first event listener, which monitors sensor changes associated with the first display. In addition, sensor manager 111 registers a second event listener with windows manager 310 to receive event notifications from when the actively operating application changes displays (block 504). Sensor manager 111 receives from the window manager a notification that the application interface is moved from the first display to the second display (block 506). Sensor manager 111 registers a second event listener that monitors sensor changes associated with the second display (block 508). Sensor manager 111 unregisters the first event listener that was previously registered to monitor sensor changes at the first display (block 510). By continuing to provide a correct set of sensors to an application that can switch displays, sensor manager 111 enables application 112 to maintain a proper presentation of the application interface on the second display (block 512). For example, if the second event listener indicates that the second display is positioned in a particular position/orientation, application 112 is able to present application interface 210 on the second display so that application interface 210 can be best presented to a user/viewer, based on the particular display position/orientation. The process ends at block 514.

In the above described flow charts, one or more of the methods may be embodied in a computer readable device containing computer readable code such that a series of functional processes are performed when the computer readable code is executed on a computing device. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, such as a service processor, or other programmable data processing apparatus to produce a machine, such that the instructions, which execute via the processor of the computer or other programmable data processing apparatus, performs the method for implementing the functions/acts specified in the flowchart and/or block diagram block or blocks.

As will be further appreciated, the processes in embodiments of the present disclosure may be implemented using any combination of software, firmware or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An information handling system (IHS) comprising:
multiple displays;
at least one sensor; and
a sensor switching sub-system having:
a window manager;
a sensor manager communicatively coupled to said window manager and to said OS and which:
maps each of the at least one sensor within the IHS to a particular one or more of the multiple displays;
receives a request for event monitoring associated with an orientation of a first display upon which is presented an application interface of an executing application;
allocates to the application a first set of the identified sensors for performing event monitoring, which sensors are associated with the first display;
activates event monitoring associated with an orientation of the first display using the first set of the identified sensors;
enables the application to properly present, to a user, the application interface on the first display using information from event monitoring;
detects when presentation of the application interface of the executing application switches from the first display to a second display of the multiple displays; and
in response to detecting that presentation of the application interface switches from the first display to the second display: dynamically allocates to the application a second set of the identified sensors to perform event monitoring associated with the second display; and activates event monitoring associated with an orientation of the second display using the second set of the identified sensors to enable the application to maintain a proper presentation of the application interface on the second display.

2. The IHS of claim 1, wherein the sensor manager:
registers sensor event listeners that monitor sensor changes associated with a display on which the application interface is presented; and
un-registers previously registered sensor event listeners when the application interface is moved from a first display to a second display.

3. The IHS of claim 2, wherein the sensor manager:
continuously tracks sensor events for each of multiple displays with a set of physical sensors associated with each display, wherein a same application code set is associated with event monitoring on the different displays.

4. The IHS of claim 1, wherein the sensor manager:
provides event monitoring for the application via an abstraction layer using a dynamically allocated set of physical sensors, wherein the abstraction layer is located on top of a sensor framework and enables an application user to move the application interface from the first display to the second display while the application is provided with continuous event monitoring by changing sets of physical sensors.

5. The IHS of claim 1, wherein:
the operating system (OS) executing on the IHS provisions a sensor set that is associated with a particular display on which the application user interface is currently being presented.

6. The IHS of claim 1, wherein:
the identified sensors include one or more of: (a) motion sensors, (b) position sensors, and (c) synthetic sensors that are implemented using multiple sensors.

7. The IHS of claim 1, wherein the sensor manager:
registers a first event listener that monitors sensor changes associated with the first display;
registers a second event listener with the window manager to receive an event notification when the application interface is moved from the first display to the second display; and
in response to the application interface being moved from the first display to the second display: receives from the window manager a notification that the application interface was moved to the second display; in response to receipt of the notification from the window manager, registers with the window manager a second event listener that monitors sensor changes associated with the second display; and unregisters the first event listener that was previously registered to monitor sensor changes at the first display.

8. The IHS of claim 1, wherein the sensor manager:
receives from the application a request for information identifying available sensors and sensor capabilities;
provides the application with the requested information; and
enables the application to calculate, using the information provided, a rate at which the application can acquire sensor data to allow the application to maintain the proper presentation of the application interface.

9. A method within an information handling system (IHS) having multiple displays, the method comprising:
a sensor manager mapping each of a plurality of identified sensors within the IHS to a particular one or more of the multiple displays;
receiving a request for event monitoring associated with an orientation of a first display upon which is presented an application interface of an application executing on the IHS;
allocating to the application a first set of the identified sensors for performing event monitoring, which sensors are associated with the first display;
activating event monitoring associated with an orientation of the first display using the first set of the identified sensors;
enabling the application to properly present, to a user, the application interface on the first display using information from event monitoring;
detecting when presentation of the application interface of the executing application switches from the first display to a second display of the multiple displays; and
in response to detecting that presentation of the application interface switches from the first display to the second display: dynamically allocating to the application a second set of the identified sensors to perform event monitoring associated with the second display; and activating event monitoring associated with orientation of the second display using the second set of the identified sensors, wherein the application maintains a proper presentation of the application interface when the application interface is moved from the first display to the second display.

10. The method of claim 9, wherein said allocating further comprises:
registering first sensor event listeners that monitor sensor changes associated with a display on which the application interface is presented;
registering a second event listener with the window manager to receive an event notification when the application interface is moved from the first display to the second display; and
un-registering previously registered sensor event listeners when the application interface is moved from a first display to a second display.

11. The method of claim 10, further comprising:
continuously tracking sensor events for each of multiple displays with a set of physical sensors associated with each display, wherein a same application code set is associated with event monitoring on the different displays.

12. The method of claim 9, wherein said mapping further comprises:
providing event monitoring for the application via an abstraction layer using a dynamically allocated set of physical sensors, wherein the abstraction layer is located on top of a sensor framework and enables an application user to move the application interface from the first display to the second display while the application is provided with continuous event monitoring by changing sets of physical sensors.

13. The method of claim 9, wherein said allocating further comprises:
an operating system (OS) executing on the IHS provisioning a sensor set that is associated with a particular display on which the application user interface is currently being presented.

14. The method of claim 9, wherein:
the identified sensors include one or more of: (a) motion sensors, (b) position sensors, and (c) synthetic sensors which are implemented using multiple sensors.

15. The method of claim 9, wherein said allocating further comprises:
a sensor manager registering an event listener with a window manager to enable the sensor manager to be notified if the application interface is moved from the first display to the second display.

16. The method of claim 9, further comprising:
receives from the application a request for information identifying available sensors and sensor capabilities;
provides the application with the requested information; and
enables the application to calculate, using the information provided, a rate at which the application can acquire sensor data to allow the application to maintain the proper presentation of the application interface.
